(19) United States
(12) Patent Application Publication
(10) Pub. No.: US 2006/0196859 A1
(43) Pub. Date: Sep. 7, 2006

(54) Laser cutting of thick metal pieces with a double-focal lens

(76) Inventors: Christophe Bertez, Vaureal (FR); Karim Chouf, Levallois Perret (FR); Hakim Maazaoui, Cergy St Christophe (FR)

Correspondence Address: Elwood Haynes, 2700 Post Oak Blvd., Suite 1800, Houston, TX, 77056, US

(21) Appl. No.: 11/324,655

(22) Filed: Jan. 3, 2006

(30) Foreign Application Priority Data
Jan. 12, 2005 (FR) 0550104

(51) Int. Cl. B23K 26/38; B23K 26/06

(52) U.S. Cl. 219/121.72; 219/121.75

(57) ABSTRACT

Methods for laser beam cutting metal workpieces with a thickness between 4 mm and 25 mm. A double focusing lens is provided to make it possible to focus a laser beam on a first focusing and a second focusing point. These points are separate from each other and both lie on the laser's optical axis. The lens has a focal length between 170 mm and 300 mm.

This application claims the benefit of priority under 35 U.S.C. §119 (a) and (b) to French Application No. 0550104, filed Jan. 12, 2005, the entire contents of which are incorporated herein by reference.

### BACKGROUND

The invention relates to a method for laser-beam cutting using a lens with double focusing and with a selected focal length.

A laser cutting method conventionally employs a laser beam put out, for example, by a laser machine of the CO₂ (λ=10.6 μm) or YAG type, which beam is focused onto the piece to be cut by an optical element, generally a lens or a mirror of given focal length. A pressurized assisting gas is usually injected into the cutting groove so as to remove the molten metal. The cutting groove is then created by relative displacement, with respect to the piece to be cut, of the cutting head comprising the focusing element delivering the beam and delivering the assisting gas.

Transmissive focusing optics, i.e. lenses, are the elements most commonly used for laser cutting because they make it possible to create a pressurized leaktight cavity in the cutting head, where the assisting gas can be injected and then leave through a tube coaxial with the laser beam.

A focusing lens comprises two dioptres or faces, on which an anti-reflecting treatment is deposited in order to limit losses due to reflection.

The material of the “core” of the lens is often zinc selenide for lasers of the CO₂ type and fused silica, glass (bk7), quartz or the like for lasers of the YAG type.

The various lens shapes mainly used at present are:
planoconvex lenses composed of a spherical dioptre and a plane dioptre,
meniscus lenses composed of two spherical dioptres. This lens shape has the advantage of minimizing the spherical aberrations with respect to planoconvex lenses, and for this reason it is very widely used in laser cutting.
aspherical lenses, in which the shape of the first dioptre is no longer a sphere of constant radius but is optimized so as to further reduce the geometrical aberrations with respect to a meniscus lens having spherical dioptres, and thus obtain greater power densities at the focusing point, especially in the case of focal lengths which are short i.e. less than 95.25 mm (3.75″). The output dioptre of aspherical lenses is generally plane in order to reduce their manufacturing cost.

All these lenses tend to focus the laser beam at a single focusing point of minimal diameter.

A laser cutting method using optics with a plurality of focusing points, improving the performance of the laser cutting method, is taught by Document WO-A-98/14302. The shape of these optics, which are of the lens or mirror type, is such that the incident laser beam is no longer focused at a single point but at two (double-focal lens) or more focusing points (multi-focal lens).

More precisely, as shown in FIG. 1, when a double-focal lens LF is used, the part of the incident beam lying outside a diameter equal to 2H is focused at a first focal point PF1 lying at a principal focal length FL; The part of the incident laser beam lying inside the diameter equal to 2H is in turn focused at a second focal point PF2 lying at a distance DF after the first focal point PF1 in the direction of the propagation of the light. This focusing lens LF with a double focusing point is produced with a different radius of curvature of one of the dioptres, that of the convex face for example, inside and outside the diameter 2H.

These types of focusing optics make it possible to achieve gains in speed, cutting quality and tolerance with respect to variations in the distance between the lens and the piece, and also make it possible to cut thicker materials than conventional lenses with a single focusing point.

Despite the teaching of this document, it has been found in practice that obtaining an efficient, high-quality cut could pose a problem for certain thicknesses.

For instance, a recurrent problem is encountered when cutting metal plates or pieces having a thickness of between 4 and 25 mm, preferably between 5 and 20 mm, for which it has been found necessary to use lenses with a focal length of more than 130 mm in order to obtain acceptable cutting performances.

These thicknesses are generally cut with standardized focal lengths of 190.5 mm (7.5 inches) or 228.6 mm (9 inches), given that it is very difficult to cut these thicknesses with shorter focal lengths. In particular, burrs are systematically formed in the lower part of the cutting groove beyond a thickness of 5 mm.

### SUMMARY

The invention includes methods to achieve the desired results, as described, but is not limited to the various embodiments disclosed.

It is an object of the present invention to provide a solution to this problem, i.e. to provide an efficient method for laser cutting pieces having a thickness of between 4 and 25 mm, preferably between 5 and 20 mm, with a double-focal lens.

The solution of the invention is a method for laser-beam cutting a metal piece having a thickness of between 4 and 25 mm, in which a double focusing lens is employed making it possible to focus the laser beam at least at a first focusing point and a second focusing point which are separate from each other and lie on the laser optical axis, characterized in that the lens has a focal length (FL) of between 170 and 300 mm.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 illustrates a schematic representation of a laser for a laser cutting procedure, according to one embodiment of the current invention;

FIG. 2 illustrates a graphical representation of cutting speed versus distance between focal points, according to one embodiment of the current invention; and

FIG. 3 illustrates a second graphical representation of cutting speed versus distance between focal points, according to another embodiment of the current invention.

### DESCRIPTION OF PREFERRED EMBODIMENTS

It is an object of the present invention to provide a solution to this problem, i.e. to provide an efficient method for laser cutting pieces having a thickness of between 4 and 25 mm, preferably between 5 and 20 mm, with a double-focal lens.

Depending on the case, the method of the invention may comprise one or more of the following characteristics:
the lens has a focal length of between 180 and 200 mm;
the lens has a focal length equal to 190.5 mm;
the lens has a central part of diameter having a first radius of curvature for focusing the first focusing point at the focal length, the said diameter being less than 20 mm;
the diameter of the lens is between 4 and 15 mm;
a piece having a thickness lying between 4 and 20 mm is cut, preferably between 6 and 12 mm;
the distance between the two focusing points is between 5 and 12 mm;
the distance between the two focusing points is between 7 and 10 mm;
the metal piece is made of stainless steel, soft steel, aluminium or aluminium alloy, titanium or titanium alloy, copper or copper alloy;
an assisting gas containing nitrogen is used;
the laser beam has a power of between 0.5 and 20 kW, preferably between 1 and 6 Kw; and
the laser beam is emitted by a laser device of the CO₂ type.

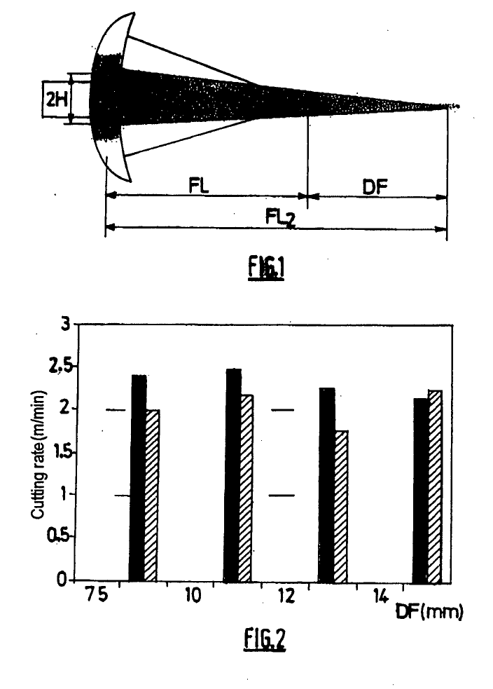

When it is related to resolving the above problem, the inventors of the present invention have noted that the laser cutting process with a double-focal lens is conditioned by the parameters of the lens being used, i.e. its focal length FL, its 2H and its 2F, as represented in FIG. 1.

The 2H of the lens corresponds to the diameter of the part lying at the centre of the lens, having a radius of curvature different from that of the exterior part of the lens. The part of the incident beam lying outside the diameter 2H is focused at a first focal point PE1 lying at a principal focal length FL. The part of the incident laser beam lying inside the diameter 2H is focused at a second focal point PF2 lying at a principal focal length FL2. The size of the diameter 2H determines the amount of energy focused at the second focusing point PF2.

The distance DF in turn corresponds to the difference between the focal lengths FL and FL2, as shown in FIG. 1.

### EXAMPLE

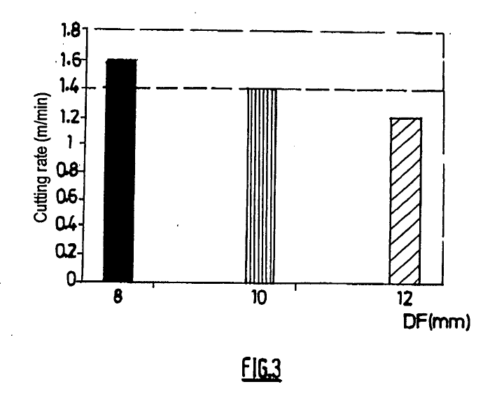

Tests carried out on stainless steel with a thickness of 6 mm and 8 mm, the results of which are respectively represented in FIGS. 2 and 3, confirm that for thicknesses of respectively between 4 and 20 mm it is suitable to use double focusing lenses of focal length FL=190.5 mm which furthermore have values of 2H lying between 4 mm and 15 mm.

The results were obtained:
for pressures of 16 bar (hatched bars) and 19 bar (black bars) in FIG. 2 by using a double-focal lens in both cases.
for pressures of 19 bar (in FIG. 3) by using either a double-focal lens (black bar) or, for comparison, a conventional mono-focal lens (hatched bars).

It is found that for the focal length FL=190.5 mm and the above values of H2, the best laser cutting performances were obtained for values of DF lying between 7 and 10 mm, as can be seen in FIG. 2.

For the sheet-metal thickness of 8 mm (FIG. 3), the double-focal lens with a distance DF equal to 8 mm makes it possible to obtain speed gains with a cutting quality unequalled by the other values of DF which were tested, in particular an absence of burring.

For these values of FL, DF and 2H, the energy distribution of laser energy absorbed in the cutting groove becomes optimal. Furthermore, the width of the groove becomes sufficient to allow good penetration of the gas and optimal removal of the molten metal.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A method which may be used for laser beam cutting comprising:
a) providing a metal workpiece to be cut with a thickness between about 4 mm and about 25 mm;
b) providing a double focusing lens, wherein the lens has a focal length of about 170 mm to about 300 mm; and
c) focusing a laser beam with the lens, wherein:
1) the laser beam is focused on at least a first and a second focusing point; and
2) the first and the second focusing points are separate from each other and lie on the laser's optical axis.

2. The method of claim 1, wherein the lens focal length is between is about 180 mm and about 200 mm.

3. The method of claim 1, wherein the focal length is about 190.5 mm.

4. The method of claim 1, wherein:
a) the lens has a central part of a diameter (2H) and a first radius of curvature suitable for focusing the first focusing point at the focal length; and
b) the diameter (2H) is less than about 20 mm.

5. The method of claim 4, wherein the diameter (2H) is between about 4 mm and about 15 mm.

6. The method of claim 1, further comprising cutting the workpiece, wherein the thickness of the workpiece is between about 4 mm and about 20 mm.

7. The method of claim 1, wherein the distance between the first and the second focusing points is between about 5 mm and about 12 mm.

8. The method of claim 7, wherein the distance is between about 7 mm and about 10 mm.

9. The method of claim 1, wherein the metal workpiece is made of at least one of selected from the group consisting of:
a) stainless steel;
b) soft steel;
c) aluminium;
d) aluminium alloy;
e) titanium;
f) titanium alloy;
g) copper; and
h) copper alloy.

10. The method of claim 1, further comprising providing an assistance gas containing nitrogen.

11. The method of claim 1, wherein the laser beam has a power between about 0.5 kW and about 20 kW.

12. The method of claim 1, wherein the laser beam is emitted by a CO₂ type laser device.

13. The method of claim 6, wherein the thickness is between about 6 mm and about 12 mm.

14. The method of claim 11, wherein the power is between about 1 kW and about 6 kW.
